(19) United States
(12) Patent Application Publication
(10) Pub. No.: US 2005/0062233 A1
(43) Pub. Date: Mar. 24, 2005

(54) Seal device for water pump, rotation supporting device for water pump, and assembly method for water pump

(75) Inventor: Masamichi Iketani, Fujisawa-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK Ltd., Shinagawa-ku (JP)

(21) Appl. No.: 10/964,827

(22) Filed: Oct. 15, 2004

Related U.S. Application Data
(63) Continuation of application No. PCT/JP03/05014, filed on Apr. 18, 2003.

(30) Foreign Application Priority Data
Apr. 23, 2002 (JP) 2002-120720

(51) Int. Cl. F16J 15/32

(52) U.S. Cl. 277/549

(57) ABSTRACT

The tip edge of a second seal lip of an elastic member constituting a seal ring is in sliding contact with a side surface of a slinger. When the slinger is fitted onto and fixed to the rotating shaft, the slinger is pressed by a pressing jig. The shape and dimension of the pressing jig are regulated such that when the tip end of the pressing jig is abutted to the end surface of the outer ring, the deformation amount of the second seal lip is made proper. Accordingly, the operation of assembly can be carried out easily in an industrial method while properly regulating the deformation amount of the second seal lip coming into sliding contact with the side surface of the slinger.

### TECHNICAL FIELD

A method of assembly for a seal apparatus for a water pump, a rotation support apparatus for a water pump, and a water pump according to the present invention relates to an improvement of a method of assembly for a seal apparatus for a water pump that is used for circulating coolant water for an automobile engine.

### BACKGROUND ART

A water pump used for circulating coolant water for an automobile engine is disclosed for example in Japanese Patent Publication No. Tokukai Hei 8-254213, and is constructed as shown in FIG. 9. A cylindrical housing 1 has a mounting flange 2 formed around its outer peripheral surface on the inside end (the inside with reference to the axial direction is the side nearest the engine, and is the right side in all of the figures) which is used for fastening to the cylinder block of the engine. A rolling bearing unit 6 comprising a ball bearing 4 on the inside and a roller bearing 5 on the outside (the outside with reference to the axial direction is the side furthest from the engine, and is the left side in all of the figures) in combination to rotatably support a rotating shaft 3, is provided on the inner diameter side of the housing 1. Seal rings 7, 7 are located on both ends in the axial direction (left and right direction in FIG. 9) of this rolling bearing unit 6 to prevent leakage of grease filled inside the bearing unit, as well as to prevent entry of foreign matter such as dirt or steam from the outside. Moreover, a pulley 8 is fastened to a section on the outside end of the aforementioned rotating shaft 3 protruding from the opening on the outside end of the housing 1.

When installed in the engine, a belt (not shown in the figure) is placed around this pulley 8 to rotate and drive the aforementioned rotating shaft 3 through the crankshaft of the engine. On the other hand, an impeller 9 is fastened to a section on the inside end of the rotating shaft 3 protruding from the inside surface of the mounting flange 2. When this mounting flange 2 is fastened to the cylinder block of the engine, the aforementioned impeller 9 fits inside the water jacket formed within the cylinder block. With rotation of the rotating shaft 3, the cooling water in the water jacket circulates to and from a radiator (not shown in the figure) or the like.

Furthermore, a mechanical seal 10 is provided between the outer peripheral surface of the rotating shaft 3 and the inner peripheral surface of the housing 1. When the engine is operating, this mechanical seal 10 allows rotation of the rotating shaft 3 while preventing leakage of steam or coolant water flowing inside the water jacket, to the outside. However, it is difficult to obtain a perfect seal with the aforementioned mechanical seal 10, and generation of frictional heat at the seal surface of this mechanical seal 10 results in evaporation of the coolant water containing chemical matter such as anti-freeze agents or anti-rust agents, forming steam, and leakage toward the rolling bearing unit 6, while at the same time, the coolant water wherein the aforementioned chemical matter is condensed due to evaporation also leaks out to the rolling bearing unit 6 side. Therefore a slinger 11 is located in the middle section of the rotating shaft 3 between the mechanical seal 10 and the inner seal ring 7, and a supply-discharge hole (not shown in the figure) is formed in the middle of the housing 1 in the section facing the outer peripheral edge of the slinger 11 to allow unrestricted discharge of steam or hot water leaking from the mechanical seal 10, to the outside of the housing 1. In other words, the aforementioned supply-discharge port communicates between the outside and a space which is provided between the mechanical seal 10 and the inner seal ring 7 in the axial direction to function as a steam chamber, so that steam and hot water in this space are discharged freely to the outside.

In the first example of the conventional construction shown in FIG. 9, the inner peripheral edges of a pair of seal lips 12, 12 forming the inner seal ring 7 come into sliding contact around the entire periphery of the outer peripheral surface of the middle section of the rotating shaft 3. Moreover, the inside seal ring 7 and the slinger 11 are not associated with, and are independent of, each other.

On the other hand, Japanese Patent Publication No. Tokukai Hei 11-153096 discloses, as shown in FIG. 10, a construction for improving seal performance by locating a seal ring 7a and a slinger 11a such that they are associated with each other. In the case of this construction, two of three lips 12a, 12b and 12c constituting the seal ring 7a, specifically the seal lips 12a and 12b, come into sliding contact around the entire periphery of the outer peripheral surface of the rotating shaft 3a. On the other hand, the tip edge of the remaining seal lip 12c comes into sliding contact around the entire periphery of the outside surface of the slinger 11a. With this kind of construction, the seal performance is improved in comparison to that of the first example of the conventional construction shown in FIG. 9, and it is possible to more effectively prevent foreign matter such as steam or hot water from entering the rolling bearing unit supporting the rotating shaft 3a.

In the case of the second example of the construction shown in FIG. 10, the seal performance is better than that of the first example of the construction shown in FIG. 9. However in order to effectively prevent foreign matter from entering the bearing unit over a long period of time, further improvement is desired. In other words, in Japanese Patent Publication No. Tokukai Hei 11-153096 wherein the construction as shown in FIG. 10 is disclosed, only a construction wherein the tip edge of one of the three seal lips 12a, 12b, and 12c forming the seal lip 7a, specifically the seal lip 12c, is in sliding contact with the outside surface of the slinger 11 is disclosed, but no detailed specifications are disclosed.

On the other hand, in order to effectively prevent entry of foreign matter into the bearing unit over a long period of time, it is necessary to satisfy the following conditions (1) and (2).
(1) The tip edge of the seal lip 12cmust come into sliding contact around the entire periphery of the outside surface of the slinger 11a without gaps and with sufficient pressure.
(2) Wear of the tip edge of the seal lip 12c due to rubbing with the outside surface of the slinger 11a must be minimized.

If only condition (1) above is to be satisfied, it is only necessary to increase the amount of elastic deformation of the seal lip 12c and increase the force pressing the tip edge of the seal lip 12c against the outside surface of the slinger 11a. On the other hand, if only condition (2) above is to be satisfied, it is only necessary to reduce the amount of elastic deformation of the seal lip 12c and reduce the force pushing the tip edge of the seal lip 12c against the outside surface of the slinger 11a.

Since the condition (1) above for securing the seal performance is counter to the condition (2) above for securing durability, it is important to implement a specific construction to effectively prevent entry of foreign matter over a long period of time, and to obtain a method of assembly of that construction providing a satisfactory yield with an industrial method.

The methods of assembly for the seal apparatus for a water pump, the rotation support apparatus for a water pump, and the water pump of the present invention has been invented in consideration of the aforementioned situation.

### DISCLOSURE OF THE INVENTION

Of a seal apparatus for a water pump, a rotation support apparatus for a water pump, and a water pump to which the assembly method of the present invention is applied, the seal apparatus for a water pump to which the method of assembly according to a first aspect is applied comprises; a seal ring having an outer peripheral edge thereof fastened to an inner peripheral surface of a non-rotating member, and a slinger fitted onto the rotating shaft, so as to block a space between the inner peripheral surface of the non-rotating member and an outer peripheral surface of the rotating shaft of the water pump which is inserted into the non-rotating member. Furthermore, the seal ring has a seal lip in sliding contact with one side face of the slinger.

Moreover, in the case of the seal apparatus for a water pump to which the method of assembly according to another aspect, comprises: an outer ring having an outer ring raceway on an inner peripheral surface; a rotating shaft constituting the water pump and having an inner ring raceway on an outer peripheral surface; a plurality of rolling elements provided between the outer ring raceway and the inner ring raceway such that they can rotate freely; a seal ring having an outer peripheral edge fastened to an inner peripheral surface on an end of the outer ring; and a slinger fitted onto the rotating shaft. Moreover, the seal ring has a seal lip in sliding contact with one side face of the slinger.

Furthermore, the water pump to which the method of assembly according to another aspect is applied comprises: a housing; an outer ring raceway provided directly on an inner peripheral surface of the housing or via a separate outer ring; a rotating shaft having an inner ring raceway on an outer peripheral surface thereof; a plurality of rolling elements provided between the outer ring raceway and the inner ring raceway such that they can roll freely; a seal ring having an outer peripheral edge thereof fastened to an inner peripheral surface on one end of the outer ring; a slinger fitted onto the rotating shaft; a pulley secured to an outer end of the rotating shaft; an impeller secured to an inner end of the rotating shaft; a mechanical seal provided at a section axially between the impeller and the slinger, between the inner peripheral surface of the housing and the outer peripheral surface of the rotating shaft; and a space provided axially between the mechanical seal and the seal ring. Moreover, the seal ring has a seal lip in sliding contact with one side face of the slinger.

Furthermore, in the case of the seal apparatus for a water pump, the rotation support for a water pump, and the water pump to which the method of assembly of the present invention is applied, the amount of compression of the seal lip associated with contact of a tip edge of the seal lip against the one side face of the slinger, is made at least 1/10 and up to 7/10 of the height of the seal lip in a free condition. In addition, the roughness of a portion at one side face of the slinger in sliding contact with the tip edge of the seal lip is made an arithmetic mean roughness Ra from 0.2 μm to 2.0 μm, or a maximum height Ry from 0.8 μm to 8.0 μm.

Preferably, the amount of compression of the seal lip is at least 2/10 and up to 5/10 the height of the seal lip in the free condition, and even more preferably at least 2/10 and up to 3/10 the height in the free condition.

Moreover, the cross-sectional shape of the seal lip is preferably such that it is increasingly tilted out in the radial direction as it becomes closer to the tip edge, and more preferably is a wedge shape wherein the width (thickness) dimension becomes smaller from the base end to the tip end. At the same time, the length dimension of the seal lip is at least two times the average thickness dimension of the seal lip, and preferably at least 2.5 times.

In the assembling method of the seal apparatus for a water pump, the rotation support for a water pump, and the water pump of the present invention, when the slinger is fitted onto the rotating shaft, the other side surface of the slinger is pushed by a pressing jig, which is movable in the axial direction, until part of the pressing jig is abutted to part of the non-rotating member, housing or outer ring.

Or, when the slinger is fitted onto the rotating shaft, the slinger is pushed by a pressing jig, which is movable in the axial direction, until part of the pressing jig is abutted to a step portion formed on the outer peripheral surface in the middle of the rotating shaft.

According to the method of assembly for the seal apparatus for a water pump, the rotation support for a water pump, and the water pump, manufactured in accordance with the method of assembly of the present invention as described above, it is possible to effectively prevent entry of foreign matter into the rolling bearing unit that supports the rotating shaft of the water pump over a long period of time.

In particular, according to the method of assembly of the present invention, it is possible to regulate through an industrial method the compression amount of the seal lip in a suitable range after the assembling is completed. Therefore it is possible to manufacture stably and at low cost the seal apparatus for a water pump, the rotation support for a water pump, and the water pump, having a stable sealing performance.

### BRIEF DESCRIPTION OF THE DRAWINGS

FIG. 1 is a partial cross-sectional view showing a first example of a construction to which the method of assembly of the present invention is applied, corresponding to portion A of FIG. 9.

FIG. 2 is a partial cross-sectional view showing a first example of an embodiment of the method of assembly of the present invention.

FIG. 3 is a partial cross-sectional view showing a second example of an embodiment of the method of assembly of the present invention. (The seal structure is substantially the same to that of the first example.) FIG. 4 is a partial cross-sectional view showing a second example of the seal construction to which the method of assembly of the present invention is applied, corresponding to portion B of FIG. 1.

FIG. 5 is a partial cross-sectional view showing a third example of the seal construction to which the method of assembly of the present invention is applied, similar to FIG. 4.

FIG. 6 is a partial cross-sectional view showing a third example of an embodiment of the method of assembly of the present invention.

FIG. 7 is a partial cross-sectional view showing a fourth example of an embodiment of the method of assembly of the present invention.

FIG. 8 (A) through FIG. 8 (D) are partial cross-sectional views showing four examples of pre-assembled seal rings and slingers with grease applied thereto.

FIG. 9 is a cross-sectional view showing a first example of a conventional water pump.

FIG. 10 is a cross-sectional view showing a second example of a conventional water pump.

### BEST MODE FOR CARRYING OUT THE INVENTION

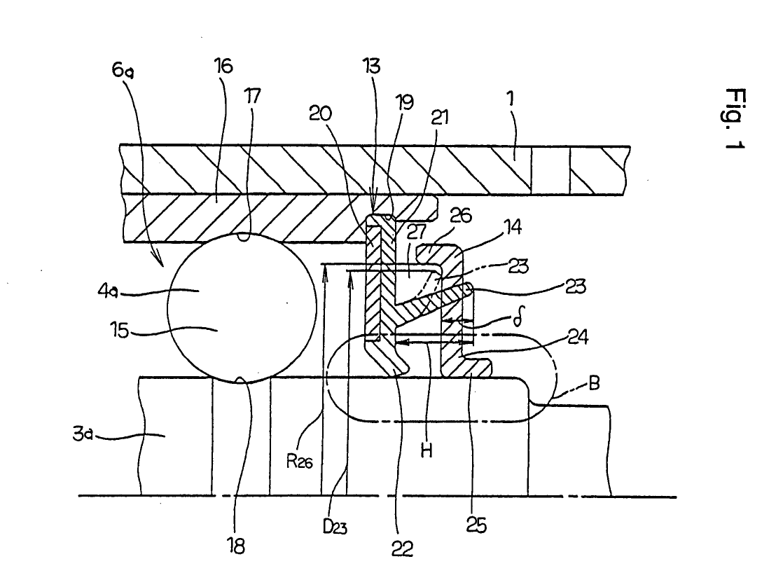

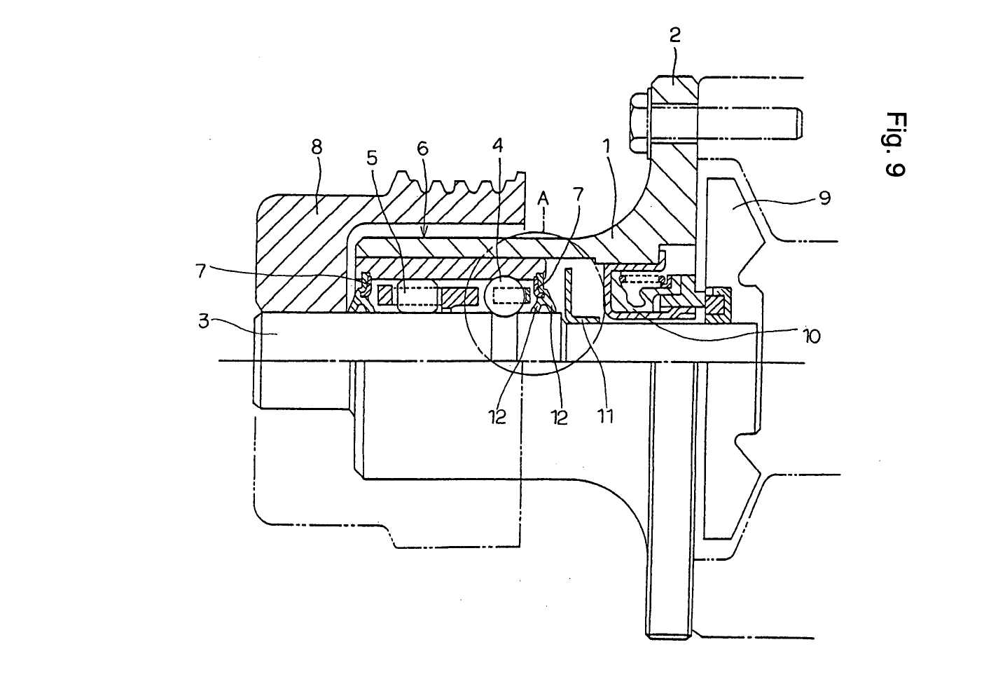

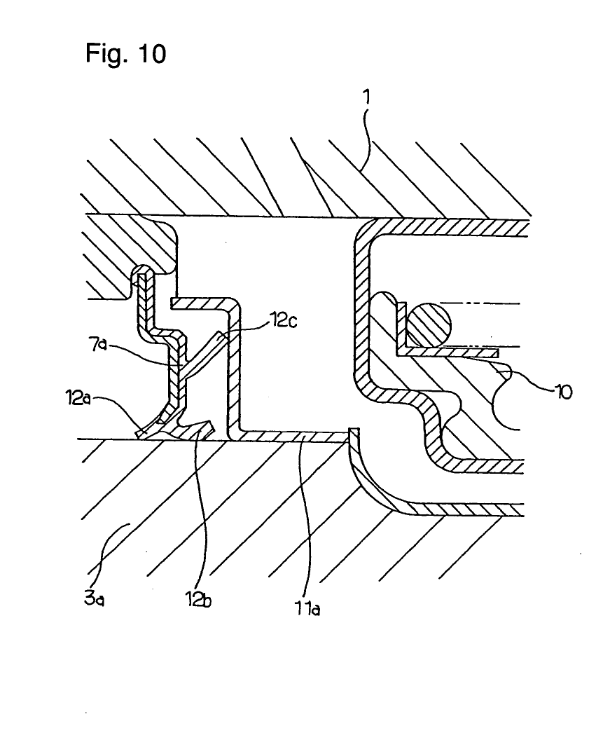

Referring to FIG. 1, the first example of the construction of a seal apparatus for a water pump to which the method of assembly of the present invention is applied is explained. The characteristics of the seal apparatus for a water pump to which the method of assembly of this example is applied are that, by suitable regulation of the shape and dimensions of the seal ring 13 and slinger 14 provided in the middle section of the rotating shaft 3a further toward the outside than the mechanical seal 10 (see FIG. 9), it is difficult for steam or hot water passing through the mechanical seal 10 to enter the rolling bearing unit 6a including the plurality of rolling elements (balls) 15. Since the overall construction and the like of the water pump, and the construction and operation of other sections are substantially the same as for a conventional water pump, including the construction shown in FIG. 9, drawings and explanations of identical sections are omitted or simplified, and the explanation will concentrate on sections that are features of the seal apparatus for a water pump covered by the method of assembly of the present invention, and sections not previously explained.

In order to construct the ball bearing 4a which forms part of the aforementioned rolling bearing unit 6a, the rolling elements 15 are held by a retainer (not shown in the figures), and in such a manner as to enable free rotation, between a deep groove-shaped outer ring raceway 17 formed around the inner peripheral surface of an outer ring 16, and a deep groove-shaped inner ring raceway 18 formed around the outer peripheral surface of the rotating shaft 3a. Also, the outer peripheral edge of the seal ring 13 is fastened to an attachment groove 19 formed around the entire inner peripheral surface on the inside end of the outer ring 16. This seal ring 13 comprises an elastic member 21 made of an elastomer such as rubber reinforced by a circular metal core 20. In the example shown in the figures, the outer peripheral edge of this elastic member 21 protrudes further outward in the radial direction than the outer peripheral edge of the metal core 20, and this outer peripheral edge of the elastic member 21 is fastened to the attachment groove 19. However, it is also possible to expose the metal core 20 at the outer peripheral edge of the seal ring 13, and to fasten this metal core 20 to the aforementioned attachment groove 19.

The elastic member 21 comprises a first seal lip 22 that comes into sliding contact with the outer peripheral surface of the rotating shaft or of the slinger, and a second seal lip 23 that comes into sliding contact with one side face of the slinger. Of these, the first seal lip 22 forms the inner peripheral edge of the seal ring 13, and it therefore comes into sliding contact around the entire circumference of the outer peripheral surface of the middle section of the rotating shaft 3a. In other words, the inner diameter of the first seal lip 22 in the free condition is slightly smaller than the outer diameter of the middle section of the rotating shaft 3a, and when the rotating shaft 3a is passed through the inner diameter side of the first seal lip 22, the inner peripheral edge of this first seal lip 22 comes in elastic contact around the outer peripheral surface of the middle section of the rotating shaft 3a around the entire circumference.

On the other hand, the second seal lip 23 extends to inwards from the side face of the elastic member 21 such that it is increasingly tilted out in the radial direction towards to the tip edge. The cross-sectional shape of this second seal lip 23 is a wedge shape where the width (thickness) dimension becomes smaller from the base toward the tip. At the same time, the length dimension of the second seal lip 23 is such that it is at least two times and preferably at least 2.5 times the average thickness of the second seal lip 23. The tip edge of this second seal lip 23 comes into sliding contact around the outside surface of the slinger 14 around the entire circumference. This outside surface of the slinger 14 is the one side face disclosed in the claims and set forth later. In this condition, the second seal lip 23 is bent (curled) such that it has a circular arc-shaped cross section.

The slinger 14 fitted onto and fastened to the middle section of the rotating shaft 3a in the section adjacent to the inside of the seal ring 13, is made of anti-corrosive metal plate such as stainless steel plate or steel plate to which anti-corrosion surface treatment has been applied such that at least the surface where the tip edge of the second seal lip 23 comes into sliding contact does not corrode, and is formed by bending it generally into a ring shape having a crank-shaped cross section. In other words, the slinger 14 comprises: an inner diameter side cylindrical section 25 formed by bending at a right angle the inner peripheral edge of the circular section 24 to the inside in the axial direction; and an outer diameter side cylindrical section 26 similarly formed by bending at a right angle the outer peripheral edge of the circular section 24 to the outside in the axial direction. By tightly fitting the inner diameter side cylindrical section 25 onto the middle section of the rotating shaft 3a with an interference fit, the slinger 14 is fastened around the outer peripheral surface of the middle section of the rotating shaft 3a . Also, the tip end of the second seal lip 23 comes into sliding contact around the outside surface of the slinger 14 around the entire circumference. The roughness of the outside surface of the slinger 14, against which the tip edge of the second seal lip 23 comes into sliding contact in this manner, is such that the arithmetic mean roughness Ra is from 0.2 μm to 2.0 μm, or the maximum height Ry is from 0.8 μm to 8.0 μm.

In the case of the seal apparatus for a water pump to which the method of assembly of the present invention is applied, by suitably regulating the distance between the seal ring 13 and the slinger 14, the amount of compression δ of the second seal lip 23 (amount of elastic compression in the axial direction from the free condition) when assembled as shown by the dot-dash line in FIG. 1 is at least 1/10 and up to 7/10 the height H of the second seal lip 23 in the free condition as shown by the solid line in the figure (H/10 ≦δ≦7H/10). Preferably, this amount of elastic deformation δ should be at least 2/10 and up to 5/10 the height of the second seal lip 23 in the free condition (2H/10≦δ≦5H/10), and even more preferably at least 2/10 and up to 3/10 (2H/10≦δ≦3H/10). Furthermore, the inner diameter R₂₆ of the outer diameter side cylindrical portion 26 provided on the outer peripheral edge of the slinger 14 is larger than the outer diameter D₂₃ of the second seal lip 23 under elastic deformation (R₂₆>D₂₃), so that there is no interference or rubbing between the tip end edge of the second seal lip 23 and the inner peripheral surface of the outer diameter side cylindrical portion 26.

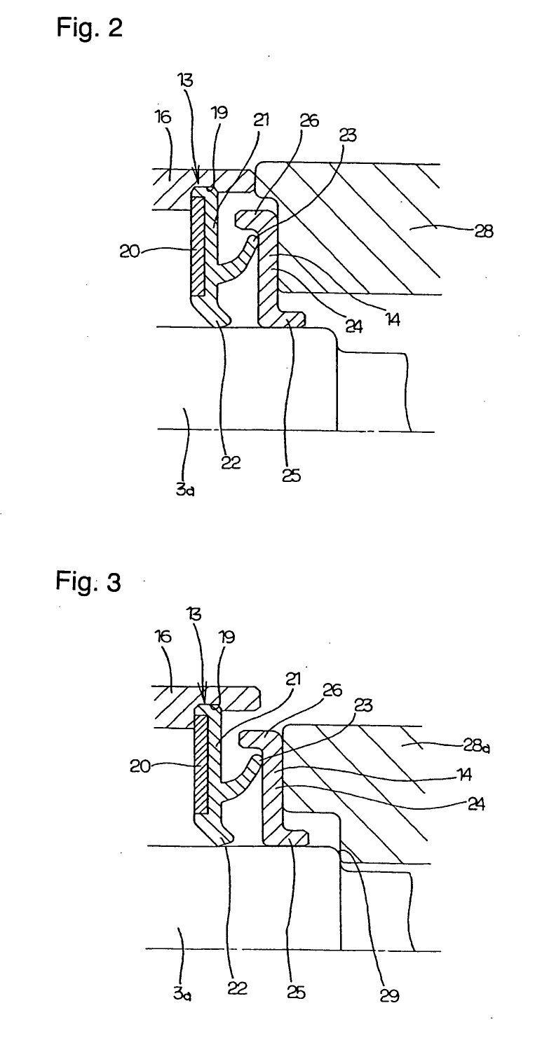

Next, two examples of the method of assembly for the seal apparatus for a water pump as shown above are explained with reference to FIG. 2 and FIG. 3. The reason for adopting the method of assembly shown in FIG. 2 and FIG. 3 is to completely regulate the compression amount δ of the seal lip 23 after the assembly is completed. Specifically, in the seal apparatus for water pump assembled according to the assembling method of the present invention, the elastic deformation amount of the second seal lip 23 is regulated to prevent foreign matter from entering the rolling bearing unit for a long period of time. Furthermore, it is important to fit the slinger 14 onto, and fasten it to, the rotating shaft 3a while regulating the position in the axial direction of the slinger 14 in sliding contact with the tip edge of the second seal lip 23.

Therefore, in the first method as shown in FIG. 2, when the slinger 14 is fitted onto the rotating shaft 3a, with the pressing jig 28 moving in the axial direction, the other side surface of the slinger 14, specifically the inside surface is pressed until part (tip end surface) of the pressing jig 28 is abutted to part (axial end surface) of the outer ring 16 (or housing). And, the shape and dimension of the pressing jig 28 are regulated such that in the state where the tip end surface of the pressing jig 28 is abutted to the axial end surface of the outer ring 16 (or housing), the compression amount δ of the second seal lip 23 is set in the range of from 1/10 to 7/10 of the height H of the second seal lip 23 in the free state.

In the second method as shown in FIG. 3, with the pressing jig 28a, the other side surface or inside surface of the slinger 14 is pressed until part (tip end surface on the inner diameter side) of the pressing jig 28a is abutted to the step section 29 formed on the outer peripheral surface in the middle portion of the rotating shaft 3a. Also in this example, the shape and dimension of the pressing jig 28a are regulated such that in the state where the tip end surface of the pressing jig 28a is abutted to the step section 29, the compression amount δ of the second seal lip 23 is set in the range of from 1/10 to 7/10 of the height H of the second seal lip 23 in the free state.

Accordingly, in each of the methods, part of the pressing jig 28, 28a is abutted to the part of the outer ring 16 or to the step section 29, so that the pressing jig 28,28a can not move any more, and in this state, the compression amount of the second seal lip 23 is set in the range of from 1/10 to 7/10 of the height H of the second seal lip 23 in the free state. Therefore, the operation to elastically deform the second seal lip 23 by a proper amount can be carried out easily through an industrial method.

According to the seal apparatus for a water pump having the aforementioned construction and assembled with the aforementioned method of assembly, it is possible to effectively prevent foreign matter such as steam or hot water from entering the rolling bearing unit 6a that supports the rotating shaft 3a of the water pump, over a long period of time

First, the reason that it is possible to improve the seal performance to prevent entry of foreign matter will be explained.

Firstly, since the second seal lip 23 is increasingly tilted out in the radial direction as it becomes closer to the tip edge, it is possible to ensure a superior effect against entry of foreign matter. In other words, when foreign matter attempting to enter the rolling bearing unit 6a enters the space 27 on the outer diameter side of the second seal lip 23 through the gap between the tip edge of the outer diameter side cylindrical portion 26 and the main portion of the seal ring 13, it presses against the outer peripheral surface of the second seal lip 23. This pressure acts in the direction that pushes the tip edge of the second seal lip 23 against the outside surface of the slinger 14. Therefore it becomes very difficult for gaps to occur in the section between the tip edge of the second seal lip 23 and the outside surface of the slinger 14.

Furthermore, if this section is exposed to (attacked by) high-temperature steam, and coolant water containing condensed chemicals such as anti-freezing agent or anti-corrosion agent, the second seal lip 23 swells due to the synergistic action of these two substances (steam and coolant water) and deforms in the circumferential direction in a wave form. Thus, even when gaps occur in a few places in the area of sliding contact between the tip edge of the second seal lip 23 and the outside surface of the slinger 14, and foreign matter attempts to enter the rolling bearing unit 6a, the foreign matter is thrown outward in the radial direction from the gap, by the centrifugal force applied to the foreign matter by contact with the outside surface of the slinger 14 rotating together with the rotating shaft 3a. As mentioned above, the inner diameter R₂₆ of the outer diameter side cylindrical portion 26 provided on the outer peripheral edge of the slinger 14 is larger than the outer diameter D₂₃ of the second seal lip 23 under elastic deformation in an arc-shape (curl shape) in cross section, and thus there is a sufficient gap between the tip edge of the second seal lip 23 and the inner peripheral surface of the outer diameter side cylindrical portion 26 to discharge the foreign matter. Therefore the foreign matter is efficiently discharged and effectively prevented from progressing into the rolling bearing unit 6a.

Secondly, since the amount of compression δ of the second seal lip 23 is ensured as at least 1/10 the height H of the second seal lip 23 in the free condition (δ≧H/10), it is possible to ensure the contact pressure at the area of sliding contact between the tip edge of the second seal lip 23 and the outside surface of the slinger 14, that occurs due to the elastic deformation of the second seal lip 23. Therefore it is difficult for gaps to occur at the area of sliding contact, making it possible to improve the seal performance. Since the amount of compression δ of the second seal lip 23 is securely at least 2/10 the height H of the second seal lip 23 in the free condition (δ≧2H/10), it is possible to further effectively improve the seal performance.

Next, the reason that it is possible to ensure the abovementioned effect of preventing entry of foreign matter over a long period of time, and improve durability, will be explained.

Firstly, since the amount of compression δ of the second seal lip 23 is kept to no more than 7/10 of the height H of the second seal lip 23 in the free condition (δ≦7H/10), it is possible to prevent the contact pressure at the area of sliding contact between the tip edge of the second seal lip 23 and the outside surface of the slinger 14, due to the elastic deformation of the second seal lip 23, from becoming excessively large. Therefore, it is possible to suppress friction at the area of contact and to keep wear of the tip edge of the second seal lip 23 to a minimum.

Secondly, the arithmetic mean roughness Ra of the outside surface of the slinger 14 in contact with the tip edge of the second seal lip is regulated at from 0.2 μm to 2.0 μm, or the maximum height Ry is regulated at from 0.8 μm to 8.0 μm (by keeping the value of at least one of the arithmetic mean roughness Ra and the maximum height Ry within the aforementioned range, the surface is a smooth surface with little roughness). Therefore the tip edge of the second seal lip 23 does not rub forcibly against the outside surface of the slinger, and it is possible to keep wear of the tip edge to a minimum. If the arithmetic mean roughness Ra of the outside surface exceeds 2.0 μm, or the maximum height Ry exceeds 8.0 μm, wear of the tip edge of the second seal lip 23 becomes severe and it becomes difficult to sufficiently ensure durability. On the other hand, if the arithmetic mean roughness Ra is less than 0.2 μm, or the maximum height Ry is less than 0.8 μm, the processing cost greatly increases, but improved durability cannot be expected.

In addition to regulating the surface roughness of the outside surface of the slinger 14 as mentioned above, the slinger 14 is made of anti-corrosive metal plate as mentioned before, such that the surface of at least the section where the tip edge of the second seal lip 23 comes into sliding contact does not corrode. Therefore roughness of the outside surface does not become worse due to corrosion, and it is possible to maintain the function of preventing wear over a long period of time.

In this way, wear of the tip edge of the second seal lip 23 is suppressed. Therefore even when the water pump is used over a long period of time, proper contact is maintained at the area of sliding contact between the tip edge of the second seal lip 23 and the outside surface of the slinger 14, and it is possible to ensure the seal performance at this area of sliding contact. It is necessary to keep at least either the value of the arithmetic mean roughness Ra or the maximum height Ry within the aforementioned respective ranges. However, it is possible to further improve durability by keeping both values within the aforementioned ranges.

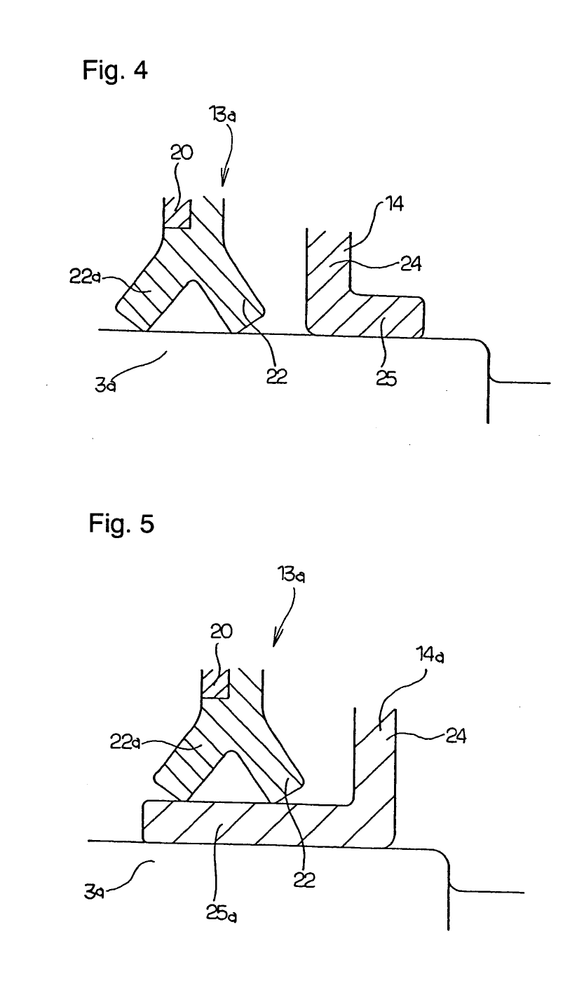

Next, FIGS. 4 and 5 show a second and third examples of the seal construction to which the method of assembly of the present invention is applied. The seal ring 13 of the first example of the seal construction to which the method of assembly of the present invention described above is applied, is provided with only one first seal lip 22 for sliding contact with the outer peripheral surface of the rotating shaft 3a. On the other hand, in this case of the seal ring 13a in the second and third examples, two first seal lips 22 and 22a tilted in opposite directions to each other are provided. The first seal lip 22a tilting outward in the axial direction as it extends toward the inner diameter side has an excellent operation and effect in relation to preventing leakage of grease filled inside the rolling bearing unit. Incidentally, in the case of the second example as shown in FIG. 4, two seal lips 22, 22a come into sliding contact with the outer peripheral surface of the rotating shaft 3a. On the other hand, in the third example as shown in FIG. 5, two seal lips 22, 22a come into sliding contact with the outer peripheral surface of the inner diameter side cylindrical portion 25a of the slinger 14a fitted onto the rotating shaft 3a.

Of the constructions of the second and third examples, as shown in FIG. 4, the method of assembly for the construction of the second example is carried out as shown in FIG. 2 and FIG. 3 similar to the first example as shown in FIG. 1.

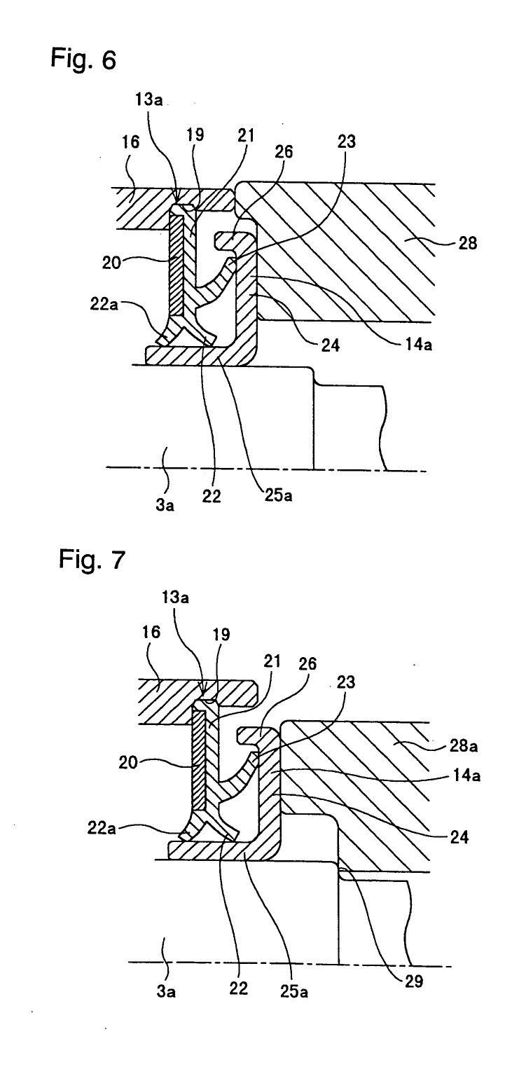

On the other hand, as in the construction of the third example as shown in FIG. 5, in the case of the construction where two seal lips 22, 22a come into sliding contact with the outer peripheral surface of the inner diameter side cylindrical portion 25a of the slinger 14a, as shown in FIGS. 6 and 7, the inner diameter side cylindrical portion 25a is inserted into the inner diameter side of the both seal lips 22, 22a, and in this state, the slinger 14a is pressed with the pressing jig 28, 28a. As in the case of the method of assembly as shown in FIGS. 2 and 3, the shape and dimensions of the pressing jig 28, 28a are regulated to control the amount of compression δ of the second seal lip 23.

When implementing the present invention, it is preferable that the hardness (Shore hardness) of the second seal lip 23 is regulated to between Hs50 and Hs90. The reason for this is to maintain the yield of the seal rings 13 and 13a, while giving suitable rigidity to the second seal lip 23, and to give a suitable contact pressure at the area of sliding contact between the tip edge of the second seal lip 23 and the outside surface of the circular section 24 of the slingers 14 and 14a. If the hardness of the second seal lip 23 is too low (less than Hs50), the contact pressure at the area of sliding contact is insufficient due to the too low hardness of the second seal lip 23, and it becomes difficult to ensure sealing performance.

On the other hand, if the hardness of the second seal lip 23 is too high (in excess of Hs90), then at the time of molding the elastic member 21 including the second seal lip 23, it becomes difficult to remove the second seal lip 23 from the mold, due to the too high hardness of the second seal lip 23. As a result, the second seal lip 23 is readily torn off, or the like, so that yield for the seal rings 13 and 13a deteriorates. Conversely, if the hardness of the second seal lip 23 is regulated to between Hs50 and Hs90, the yield for the seal rings 13 and 13a is maintained, and the required sealing performance can be ensured. For the same reason, it is preferable that the hardness of the first seal lip 22, 22a, as well, be regulated to between Hs50 and Hs90.

Furthermore, as shown in FIG. 5, when adopting the structure where the first seal lip 22, 22a comes in sliding contact with the outer peripheral surface of the radially inner cylindrical portion 25a of the slinger 14a, it is desirable that the seal ring 13, 13a and slinger 14a are previously combined before being installed between the inner peripheral surface of the non-rotating member or outer ring 16 or housing and the outer peripheral surface of the rotating shaft 3a. The reason of this is that the first seal lip 22, 22a and second seal lip23 are protected by the slinger 14a before assembling, so that foreign matter such as dust is prevented from adhering the seal lips 22, 22a, 23, and/or any damage such as flaws is prevented from being produced on the seal lips 22, 22a, 23.

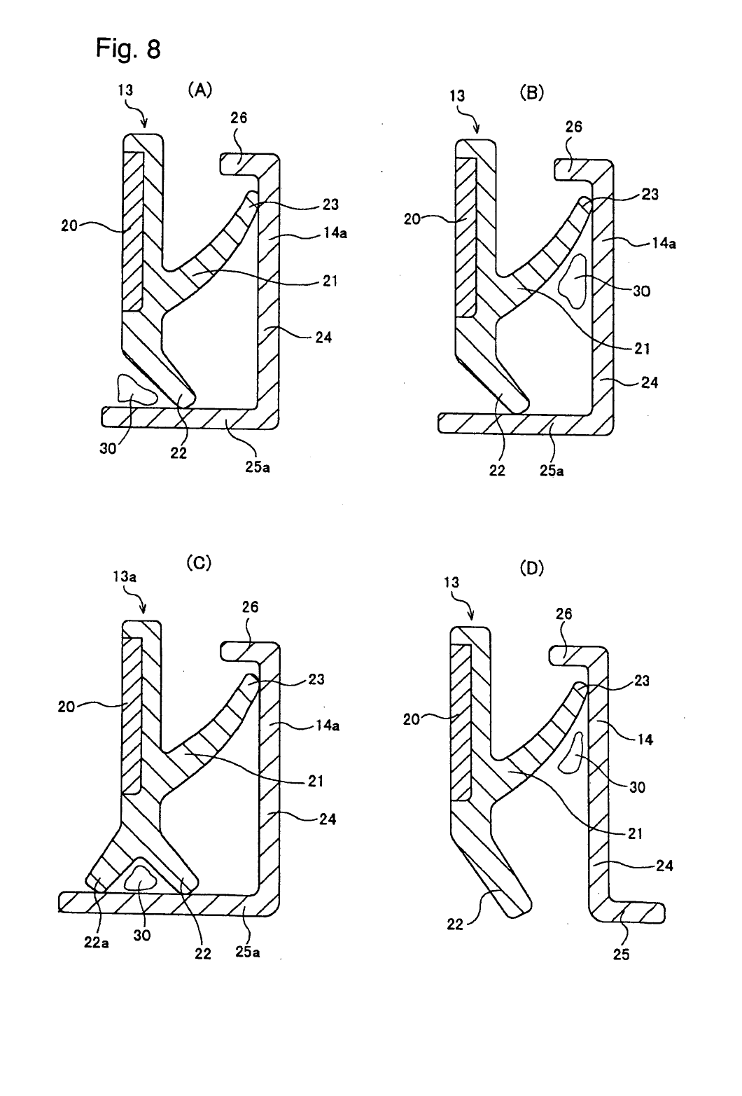

It is desirable that grease 30 is coated on part of the seal rings 13, 13a after being assembled as shown in FIG. 8 (A) through FIG. 8 (D) when the seal ring 13, 13a and slinger 14a are previously combined. And then the pre-assembly of the seal ring 13,13a and slinger 14a is installed between the inner peripheral surface of the outer ring 16 or housing 1 and the outer peripheral surface of the rotating shaft 3a . As shown in FIG. 8 (A) through FIG. 8 (D), the grease 30 is applied in the vicinity of the tip edges of the first and second seal lips 22, 22a, and 23, in other words, in the vicinity of the area of sliding contact between the tip edges of the first and second seal lips 22, 22a, and 23 and the mating surfaces. Application of grease 30 between both peripheral surfaces in this manner prior to assembly facilitates application, while ensuring that grease is applied reliably in the required locations.

### Industrial Applicability

The present invention is constructed and operates as described above. Therefore, the construction can be assembled at low cost by an industrial method, without increased cost or size, and water pump durability can be improved.

1. A method of assembly for a seal apparatus for a water pump, the seal apparatus comprising a seal ring with an outer peripheral edge fastened to an inner peripheral surface of a non-rotating member, and a slinger fitted onto a rotating shaft constituting the water pump and passing through said non-rotating member, for blocking a space between the inner peripheral surface of said non-rotating member and an outer peripheral surface of the rotating shaft, the seal ring having a seal lip in sliding contact with one side face of said slinger, the method of assembly comprising, when the slinger is fitted onto the rotating shaft for assembling the seal apparatus, pressing the other side surface of the slinger with a pressing jig which is movable in the axial direction until part of the pressing jig is abutted to part of the non-rotating member or to a step portion formed on the rotating shaft.

2. A method of assembly for a rotation support apparatus for a water pump ; the rotation support apparatus comprising an outer ring having an outer ring raceway on an inner peripheral surface thereof, a rotating shaft constituting the water pump and having an inner ring raceway on an outer peripheral surface thereof, a plurality of rolling elements provided between the outer ring raceway and the inner ring raceway such that they can rotate freely, a seal ring with an outer peripheral edge fastened to an inner peripheral surface on an end of said outer ring, and a slinger fitted onto the rotating shaft, the seal ring having a seal lip in sliding contact with one side face of said slinger, the method of assembly comprising, when the slinger is fitted onto the rotating shaft for assembling the seal apparatus, pressing the other side surface of the slinger with a pressing jig which is movable in the axial direction until part of the pressing jig is abutted to part of the non-rotating member or to a step portion formed on the rotating shaft.

3. A method of assembly of a water pump comprising a housing, an outer ring raceway formed directly on the inner peripheral surface of the housing or through a separate outer ring, a rotating shaft having an inner ring raceway on the outer peripheral surface thereof, a plurality of rolling members provided between the outer ring raceway and the inner ring raceway such that they freely roll, a seal ring with an outer peripheral edge fastened to the inner peripheral surface of one end of the outer ring, a slinger fitted onto the rotating shaft, a pulley fixed to the outside end of the rotating shaft, an impeller fixed to the inside end of the rotating shaft, a mechanical seal provided between the impeller and slinger in the axial direction and between the inner peripheral surface of the housing and the outer peripheral surface of the rotating shaft, and a space provided between the mechanical seal and the seal ring in the axial direction, the seal ring having a seal lip in sliding contact with one side face of said slinger, the method of assembly comprising, when the water pump is assembled, pressing the other side surface of the slinger with a pressing jig which is movable in the axial direction until part of the pressing jig is abutted to part of the housing or outer ring or to a step portion formed on the outer peripheral surface of the rotating shaft.
